(19) United States
(12) Patent Application Publication
(10) Pub. No.: US 2019/0217859 A1
(43) Pub. Date: Jul. 18, 2019

(54) VEHICLE CONTROL APPARATUS

(71) Applicant: Honda Motor Co., Ltd., Tokyo (JP)

(72) Inventors: Yoshiaki Konishi, Wako-shi (JP); Akira Kito, Wako-shi (JP); Toshiyuki Mizuno, Wako-shi (JP); Takayuki Kishi, Wako-shi (JP)

(21) Appl. No.: 16/245,207

(22) Filed: Jan. 10, 2019

(30) Foreign Application Priority Data
Jan. 15, 2018 (JP) 2018-004383

(51) Int. Cl. B60W 30/14; B60W 10/06; B60W 10/11

(52) U.S. Cl. CPC B60W 30/143; B60W 10/11; B60W 10/06

(57) ABSTRACT

A vehicle control apparatus including a microprocessor configured to perform generating an action plan; setting a target speed ratio of the transmission corresponding to a required driving force required after completion of a turn traveling based on the action plan; determining whether a current speed ratio during deceleration traveling or after the deceleration traveling before the vehicle starts the turn traveling is greater or smaller than the target speed ratio; controlling the transmission in accordance with a result determined by the determining, and the controlling including controlling the transmission so as to decrease a speed ratio to the target speed ratio before the vehicle starts the turn traveling, when it is determined that the current speed ratio is greater than the target speed ratio.

### CROSS-REFERENCE TO RELATED APPLICATION

This application is based upon and claims the benefit of priority from Japanese Patent Application No. 2018-004383 filed on Jan. 15, 2018, the content of which is incorporated herein by reference.

### BACKGROUND OF THE INVENTION

### Field of the Invention

This invention relates to a vehicle control apparatus configured to control an operation during turn traveling of a vehicle having a self-drive function.

### Description of the Related Art

Conventionally, an apparatus is known that responds to detection of vehicle turn traveling (traveling along a curved road) by prohibiting an operation of shifting in order to stabilize a vehicle behavior during turn traveling. An apparatus of this type is described in Japanese Unexamined Patent Publication No. 2004-347032 (JP2004-347032A), for example.

However, when the operation of shifting is prohibited during turn traveling as in the apparatus taught by JP2004-347032A, turn traveling is apt to be performed with speed ratio kept at a low stage. When this happens in a vehicle powered by an engine, for example, vehicle control performance is degraded because vehicle driving force changes greatly relative to amount of throttle opening angle.

### SUMMARY OF THE INVENTION

An aspect of the present invention is a vehicle control apparatus configured to control a drive power source and a transmission connected to the drive power source, the drive power source and the transmission being mounted on a vehicle having a self-drive function. The vehicle control apparatus includes an electric control unit including a microprocessor and a memory. The microprocessor is configured to perform: generating an action plan of the vehicle; setting a target speed ratio of the transmission corresponding to a required driving force required after completion of a turn traveling of the vehicle based on the action plan generated in the generating, before the vehicle starts the turn traveling; determining whether a current speed ratio during deceleration traveling or after the deceleration traveling before the vehicle starts the turn traveling is greater or smaller than the target speed ratio set in the setting; controlling the transmission in accordance with a result determined by the determining, and the controlling including controlling the transmission so as to decrease a speed ratio to the target speed ratio before the vehicle starts the turn traveling, when it is determined that the current speed ratio is greater than the target speed ratio.

### BRIEF DESCRIPTION OF THE DRAWINGS

The objects, features, and advantages of the present invention will become clearer from the following description of embodiments in relation to the attached drawings, in which:

FIG. 1 is a diagram showing a configuration overview of a driving system of a self-driving vehicle to which a vehicle control apparatus according to an embodiment of the present invention is applied;

FIG. 2 is a block diagram schematically illustrating overall configuration of the vehicle control apparatus according to an embodiment of the present invention;

FIG. 3 is a diagram showing an example of an action plan generated by an action plan generation unit of FIG. 2;

FIG. 4 is a diagram showing an example of a shift map used in shift controlling by the vehicle control apparatus according to the embodiment of the present invention;

FIG. 5 is a diagram showing an example of shifting at a time of turn traveling by the vehicle control apparatus according to the embodiment of the present invention;

FIG. 6 is a block diagram illustrating main configuration of the vehicle control apparatus according to the embodiment of the present invention; and

FIG. 7 is a flow chart showing an example of processing performed by a processing unit of FIG. 2.

### DETAILED DESCRIPTION OF THE INVENTION

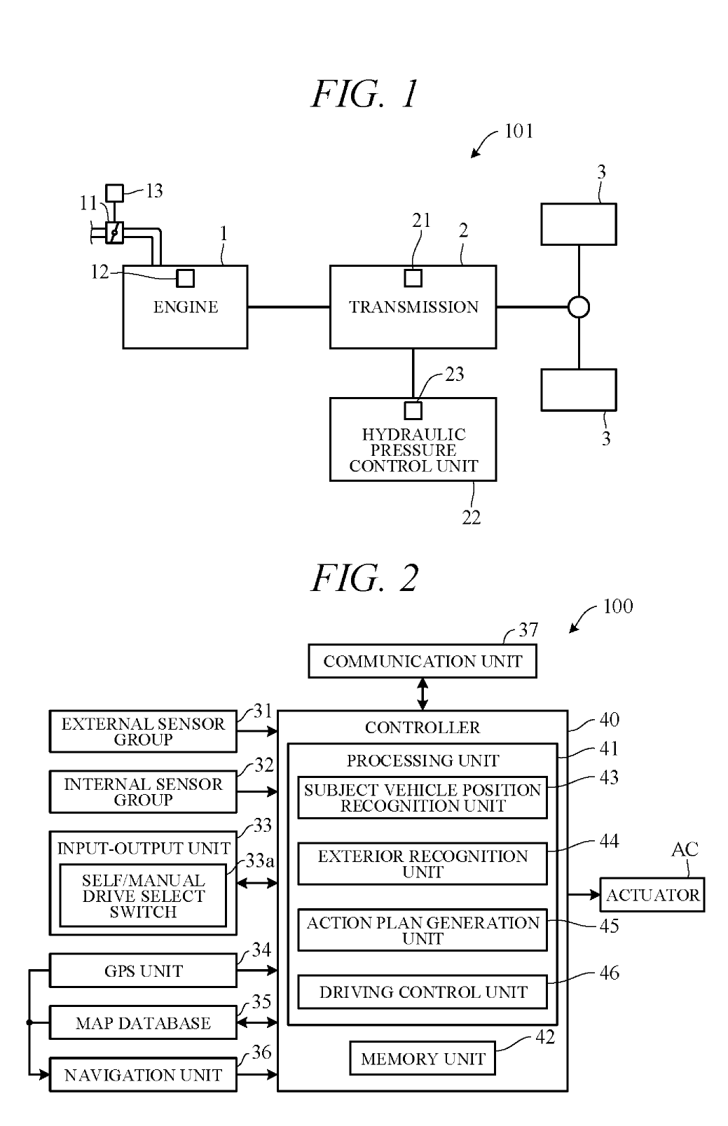

Hereinafter, an embodiment of the present invention is explained with reference to FIGS. 1 to 7. A vehicle control apparatus according to an embodiment of the present invention is applied to a vehicle (self-driving vehicle) having a self-driving capability. FIG. 1 is a diagram showing a configuration overview of a driving system of a self-driving vehicle 101 incorporating a vehicle control apparatus according to the present embodiment. Herein, the self-driving vehicle may be sometimes called subject vehicle to differentiate it from other vehicles. The vehicle 101 is not limited to driving in a self-drive mode requiring no driver driving operations but is also capable of driving in a manual drive mode by driver operations.

As shown in FIG. 1, the vehicle 101 includes an engine 1 and a transmission 2. The engine 1 is an internal combustion engine (e.g., gasoline engine) wherein intake air supplied through a throttle valve and fuel injected from an injector are mixed at an appropriate ratio and thereafter ignited by a sparkplug or the like to burn explosively and thereby generate rotational power. A diesel engine or any of various other types of engine can be used instead of a gasoline engine. Air intake volume is metered by the throttle valve. An opening angle of the throttle valve 11 (throttle opening angle) is changed by a throttle actuator 13 operated by an electric signal. The opening angle of the throttle valve 11 and an amount of fuel injected from the injector 12 (injection timing and injection time) are controlled by a controller 40 (FIG. 2).

The transmission 2, which is installed in a power transmission path between the engine 1 and drive wheels 3, varies speed ratio of rotation of from the engine 1, and converts and outputs torque from the engine 1. The rotation of speed converted by the transmission 2 is transmitted to the drive wheels 3, thereby propelling the vehicle 101. Optionally, the vehicle 101 can be configured as an electric vehicle or hybrid vehicle by providing a drive motor as a drive power source in place of or in addition to the engine 1.

The transmission 2 is, for example, a stepped transmission enabling stepwise speed ratio (gear ratio) shifting in accordance with multiple (e.g. six) speed stages. Optionally, a continuously variable transmission enabling stepless speed ratio shifting can be used as the transmission 2. Although omitted in the drawings, power from the engine 1 can be input to the transmission 2 through a torque converter. The transmission 2 can, for example, incorporate a dog clutch, friction clutch or other engaging element 21. A hydraulic pressure control unit 22 can shift speed stage of the transmission 2 by controlling flow of oil to the engaging element 21. The hydraulic pressure control unit 22 includes a solenoid valve or other valve mechanism operated by electric signals (called “shift actuator 23” for sake of convenience), and an appropriate speed stage can be implemented by changing flow of hydraulic pressure to the engaging element 21 in response to operation of the shift actuator 23.

FIG. 2 is a block diagram schematically illustrating overall configuration of a vehicle control apparatus (vehicle travel control system) 100 according to an embodiment of the present invention. As shown in FIG. 2, the vehicle control apparatus 100 includes mainly of the controller 40, and as members communicably connected with the controller 40 through CAN (Controller Area Network) communication or the like, an external sensor group 31, an internal sensor group 32, an input-output unit 33, a GPS unit 34, a map database 35, a navigation unit 36, a communication unit 37, and actuators AC.

The term external sensor group 31 herein is a collective designation encompassing multiple sensors (external sensors) for detecting external circumstances constituting subject vehicle ambience data. For example, the external sensor group 31 includes, inter alia, a LIDAR (Light Detection and Ranging) for measuring distance from the vehicle to ambient obstacles by measuring scattered light produced by laser light radiated from the subject vehicle in every direction, a RADAR (Radio Detection and Ranging) for detecting other vehicles and obstacles around the subject vehicle by radiating electromagnetic waves and detecting reflected waves, and a CCD, CMOS or other image sensor-equipped on-board cameras for imaging subject vehicle ambience (forward, reward and sideways).

The term internal sensor group 32 herein is a collective designation encompassing multiple sensors (internal sensors) for detecting subject vehicle driving state. For example, the internal sensor group 32 includes, inter alia, an engine speed sensor for detecting engine rotational speed, a vehicle speed sensor for detecting subject vehicle running speed, acceleration sensors for detecting subject vehicle forward-rearward direction acceleration and lateral acceleration, respectively, a yaw rate sensor for detecting rotation angle speed around a vertical axis through subject vehicle center of gravity, and a throttle opening sensor for detecting throttle opening angle. The internal sensor group 32 also includes sensors for detecting driver driving operations in manual drive mode, including, for example, accelerator pedal operations, brake pedal operations, steering wheel operations and the like.

The term input-output unit 33 is used herein as a collective designation encompassing apparatuses receiving instructions input by the driver and outputting information to the driver. For example, the input-output unit 33 includes, inter alia, switches which the driver uses to input various instructions, a microphone which the driver uses to input voice instructions, a display for presenting information to the driver via displayed images, and a speaker for presenting information to the driver by voice. In FIG. 2, as an example of various switches constituting the input-output unit 33, a self/manual drive select switch 33a for instructing either self-drive mode or manual drive mode is shown.

The self/manual drive select switch 33a, for example, is configured as a switch manually operable by the driver to output instructions of switching to the self-drive mode enabling self-drive functions when the switch is operated to ON and the manual drive mode disabling self-drive functions when the switch is operated to OFF. Optionally, the self/manual drive select switch can be configured to instruct switching from manual drive mode to self-drive mode or from self-drive mode to manual drive mode when a predetermined condition is satisfied without operating the self/manual drive select switch 33a. In other words, drive mode can be switched automatically not manually in response to automatic switching of the self/manual drive select switch.

The GPS unit 34 includes a GPS receiver for receiving position determination signals from multiple GPS satellites, and measures absolute position (latitude, longitude and the like) of the subject vehicle based on the signals received from the GPS receiver.

The map database 35 is a unit storing general map data used by the navigation unit 36 and is, for example, implemented using a hard disk. The map data include road position data and road shape (curvature etc.) data, along with intersection and road branch position data. The map data stored in the map database 35 are different from high-accuracy map data stored in a memory unit 42 of the controller 40.

The navigation unit 36 retrieves target road routes to destinations input by the driver and performs guidance along selected target routes. Destination input and target route guidance is performed through the input-output unit 33. Target routes are computed based on subject vehicle current position measured by the GPS unit 34 and map data stored in the map database 35.

The communication unit 37 communicates through networks including the Internet and other wireless communication networks to access servers (not shown in the drawings) to acquire map data, traffic data and the like, periodically or at arbitrary times. Acquired map data are output to the map database 35 and/or memory unit 42 to update their stored map data. Acquired traffic data include congestion data and traffic light data including, for instance, time to change from red light to green light.

The actuators AC are provided to perform driving of the vehicle 101. The actuators AC include a throttle actuator 13 for adjusting opening angle of the throttle valve of the engine 1 (throttle opening angle), a shift actuator 23 for changing speed stage of the transmission 2, a brake actuator for operating a braking device, and a steering actuator for driving a steering unit.

The controller 40 is constituted by an electronic control unit (ECU). In FIG. 2, the controller 40 is integrally configured by consolidating multiple function-differentiated ECUs such as an engine control ECU, a transmission control ECU, a clutch control ECU and so on. Optionally, these ECUs can be individually provided. The controller 40 incorporates a computer including a CPU or other processing unit (a microprocessor) 41, the memory unit (a memory) 42 of RAM, ROM, hard disk and the like, and other peripheral circuits not shown in the drawings.

The memory unit 42 stores high-accuracy detailed map data including, inter alia, lane center position data and lane boundary line data. More specifically, road data, traffic regulation data, address data, facility data, telephone number data and the like are stored as map data. The road data include data identifying roads by type such as expressway, toll road and national highway, and data on, inter alia, number of road lanes, individual lane width, road gradient, road 3D coordinate position, lane curvature, lane merge and branch point positions, and road signs. The traffic regulation data include, inter alia, data on lanes subject to traffic restriction or closure owing to construction work and the like. The memory unit 42 also stores a shift map (shift chart) serving as a shift operation reference, various programs for performing processing, and threshold values used in the programs, etc.

As functional configurations, the processing unit 41 includes a subject vehicle position recognition unit 43, an exterior recognition unit 44, an action plan generation unit 45, and a driving control unit 46.

The subject vehicle position recognition unit 43 recognizes map position of the subject vehicle (subject vehicle position) based on subject vehicle position data calculated by the GPS unit 34 and map data stored in the map database 35. Optionally, the subject vehicle position can be recognized using map data (building shape data and the like) stored in the memory unit 42 and ambience data of the vehicle 101 detected by the external sensor group 31, whereby the subject vehicle position can be recognized with high accuracy. Optionally, when the subject vehicle position can be measured by sensors installed externally on the road or by the roadside, the subject vehicle position can be recognized with high accuracy by communicating with such sensors through the communication unit 37.

The exterior recognition unit 44 recognizes external circumstances around the subject vehicle based on signals from cameras, LIDERs, RADARs and the like of the external sensor group 31. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road boundary and stop lines, buildings, guardrails, power poles, commercial signs, pedestrians, bicycles, and the like. Recognized states of other objects include, for example, traffic light color (red, green or yellow) and moving speed and direction of pedestrians and bicycles.

The action plan generation unit 45 generates a subject vehicle driving path (target path) from present time point to a certain time ahead based on, for example, a target route computed by the navigation unit 36, subject vehicle position recognized by the subject vehicle position recognition unit 43, and external circumstances recognized by the exterior recognition unit 44. When multiple paths are available on the target route as target path candidates, the action plan generation unit 45 selects from among them the path that optimally satisfies legal compliance, safe efficient driving and other criteria, and defines the selected path as the target path. The action plan generation unit 45 then generates an action plan matched to the generated target path. An action plan is also called “travel plan”.

The action plan includes action plan data set for every unit time Δt (e.g., 0.1 sec) between present time point and a predetermined time period T (e.g., 5 sec) ahead, i.e., includes action plan data set in association with every unit time Δt interval. The action plan data include subject vehicle position data and vehicle state data for every unit time Δt. The position data are, for example, target point data indicating 2D coordinate position on road, and the vehicle state data are vehicle speed data indicating vehicle speed, direction data indicating subject vehicle direction, and the like. Therefore, when accelerating the subject vehicle to target vehicle speed within the predetermined time period T, the action plan includes target vehicle speed data. The vehicle state data can be determined from position data change of successive unit times Δt. Action plan is updated every unit time Δt.

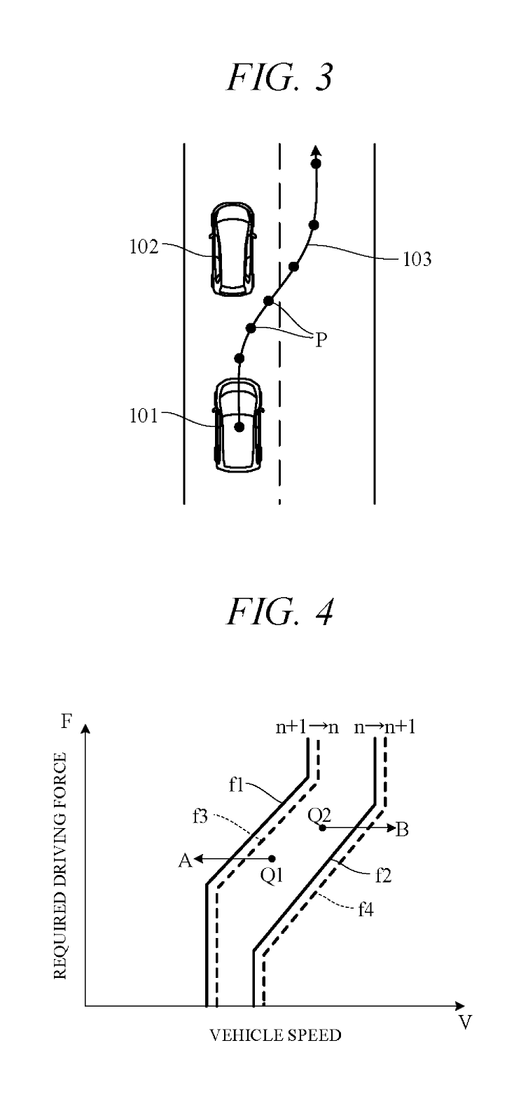

FIG. 3 is a diagram showing an action plan generated by the action plan generation unit 45. FIG. 3 shows a scene depicting an action plan for the subject vehicle 101 when changing lanes and overtaking a vehicle 102 ahead. Points P in FIG. 3 correspond to position data at every unit time Δt between present time point and predetermined time period T1 ahead. A target path 103 is obtained by connecting the points P in time order. The action plan generation unit 45 generates not only overtake action plans but also various other kinds of action plans for, inter alia, lane-changing to move from one traffic lane to another, lane-keeping to maintain same lane and not stray into another, and decelerating or accelerating.

When generating a target path, the action plan generation unit 45 first decides a drive mode and generates the target path in line with the drive mode. When creating an action plan for lane-keeping, for example, the action plan generation unit 45 firsts decides drive mode from among modes such as cruising, following, decelerating, and turn traveling (traveling along curved road). To cite particular cases, the action plan generation unit 45 decides cruising mode as drive mode when no other vehicle is present ahead of the subject vehicle (no forward vehicle) and decides following mode as drive mode when a vehicle ahead is present. The action plan generation unit determines whether turn traveling is started based on the subject vehicle position on the map recognized by the subject vehicle position recognition unit 43, and decides turn traveling mode as drive mode when determining that turn traveling is started. Optionally, the action plan generation unit may decide turn traveling mode as drive mode when an entry of the subject vehicle into curved road is recognized by the exterior recognition unit 44.

Further, the action plan generation unit 45 determines whether an obstacle is present based on signals from the external sensor group 31 and whether an avoidance action for avoiding the obstacle is necessary. When it is determined that the avoidance action is necessary, the action plan generation unit 45 generates an action plan (target path) so as to avoid the obstacle.

In self-drive mode, the driving control unit 46 controls the actuators AC to drive the subject vehicle 101 along target path 103 generated by the action plan generation unit 45. For example, the driving control unit 46 controls the throttle actuator 13, shift actuator 23, brake actuator and steering actuator so as to drive the subject vehicle 101 through the points P of the unit times Δt in FIG. 3.

More specifically, in self-drive mode, the driving control unit 46 calculates acceleration (target acceleration) of sequential unit times Δt based on vehicle speed (target vehicle speed) at points P of sequential unit times Δt on target path 103 (FIG. 3) included in the action plan generated by the action plan generation unit 45. In addition, the driving control unit 46 calculates required driving force for achieving the target accelerations taking running resistance caused by road gradient and the like into account. And the actuators AC are feedback controlled to bring actual acceleration detected by the internal sensor group 32, for example, into coincidence with target acceleration. On the other hand, in manual drive mode, the driving control unit 46 controls the actuators AC in accordance with driving instructions by the driver (accelerator opening angle and the like) acquired from the internal sensor group 32.

Controlling of the transmission 2 by the driving control unit 46 is explained concretely. The driving control unit 46 controls shift operation (shifting) of the transmission 2 by outputting control signals to the shift actuator 23 using a shift map stored in the memory unit 42 in advance to serve as a shift operation reference.

FIG. 4 is a diagram showing an example of the shift map stored in the memory unit 42. In the drawing, horizontal axis is scaled for vehicle speed V and vertical axis for required driving force F. Required driving force F is in one-to-one correspondence to accelerator opening angle which is an amount of operation of an accelerator (in self-drive mode, simulated accelerator opening angle) or throttle opening angle, and required driving force F increases with increasing accelerator opening angle or throttle opening angle. Therefore, the vertical axis can instead be scaled for accelerator opening angle or throttle opening angle.

In FIG. 4, characteristic curve f1 (solid line) is an example of a downshift curve corresponding to downshift from n+1 stage to n stage in self-drive mode and characteristic curve f2 (solid line) is an example of an upshift curve corresponding to upshift from n stage to n+1 stage in self-drive mode. Characteristic curve f3 (dashed line) is an example of a downshift curve corresponding to downshift from n+1 stage to n stage in manual drive mode and characteristic curve f4 (dashed line) is an example of an upshift curve corresponding to upshift from n stage to n+1 stage in manual drive mode. Characteristic curves f3 and f4 are shifted to high vehicle speed side than characteristic curves f1 and f2, respectively.

For example, considering downshift from operating point Q1 in FIG. 4, in a case where vehicle speed V decreases under constant required driving force F, the transmission 2 downshifts from n+1 stage to n stage when operating point Q1 crosses downshift curves (characteristic curves f1, f3; arrow A). Also, in a case where required driving force F increases under constant vehicle speed V, the transmission 2 downshifts when operating point Q1 crosses downshift curves.

On the other hand, considering upshift from operating point Q2, in a case where vehicle speed V increases under constant required driving force F, the transmission 2 upshifts from n stage to n+1 stage when operating point Q2 crosses upshift curves (characteristic curves f2, f4; arrow B). Also, in a case where required driving force F decreases under constant vehicle speed V, the transmission 2 upshifts when operating point Q1 crosses upshift curves. Downshift curves and upshift curves are shifted to high speed side along with an increase of speed stage.

Characteristic curves f3 and f4 in manual drive mode are characteristic curves that balance fuel economy performance and power performance. On the other hand, characteristic curves f1 and f2 in self-drive mode are characteristic curves that prioritize fuel economy performance or silent performance over power performance. Since characteristic curves f1 and f2 are shifted to low vehicle speed side than characteristic curves f3 and f4, upshift time is advanced and downshift time is delayed in self-drive mode. Therefore, the subject vehicle in self-drive mode tends to travel at speed stage greater than in manual drive mode.

Characterizing structural features of the present embodiment are explained against the foregoing backdrop in the following. The vehicle control apparatus 100 of the present embodiment is characterized in the configuration of the processing unit 41, particularly in the configuration of the driving control unit 46 for controlling shifting of the transmission and the like during traveling along curved road (turn traveling). An explanation of this aspect follows.

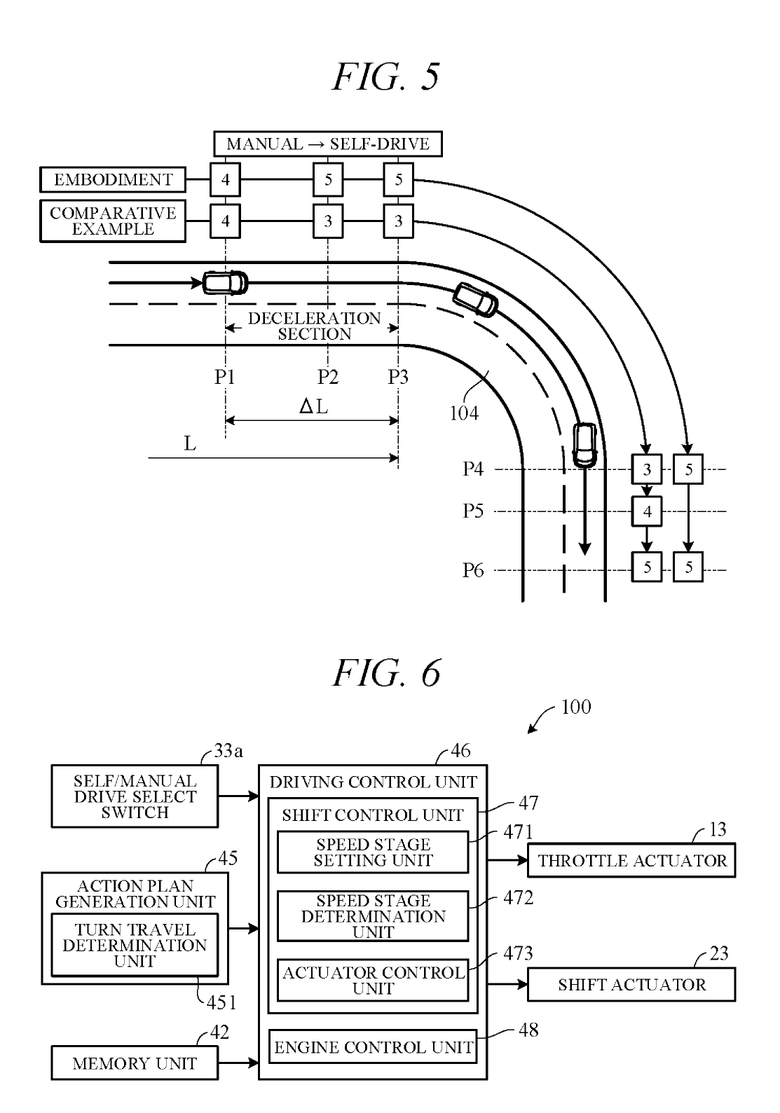

An example for comparison with the present embodiment will be explained first. FIG. 5 is a diagram showing examples of shifting during turn traveling by the present embodiment and by a comparative example. The examples of FIG. 5 presume that a vehicle (subject vehicle) is traveling a curve 104 along a target path 103 generated by the action plan generation unit 45. The examples of FIG. 5 additionally presume that the subject vehicle begins decelerating at point P1 before entering curve 104 and is switched from manual drive mode to self-drive mode during deceleration by instruction from the self/manual drive select switch 33a at point P2 preceding point P3. From point P1 to point P3 is, for example, a deceleration section. In this section, vehicle speed is decelerated by operation of the braking device. The deceleration section can optionally be point P1 to point P2.

In the comparative example, the transmission downshifts from fourth speed to third speed at point P2 in accordance with a predefined shift map (e.g., characteristic curve f1 of FIG. 4), and maintains the post-downshift speed stage (third speed) while turn traveling between point P3 where the curve starts and point P4 where the curve ends. Then, while reaccelerating after completing turn traveling at point P4, sequentially upshifts at points P5 and P6 from third speed to fourth speed and to fifth speed in accordance with a shift map (e.g., characteristic curve f2 of FIG. 4). Since the subject vehicle thus holds the current speed stage (shift-hold control) between points P3 and P4 while turn traveling, behavior of the vehicle can be stabilized during turn traveling. Moreover, owing to the preparatory downshift of the transmission 2 at point P2 before turn traveling, vehicle driving force can be increased and acceleration performance enhanced when reaccelerating after cornering is completed.

However, in a configuration that, as in the comparative example, downshifts before turn traveling and travels the curve in the post-downshift speed stage, vehicle driving force change relative to throttle angle change increases as speed stage is lower. As a result, control performance of the subject vehicle declines and vehicle behavior is easily disrupted, so that accurate control of actual driving force to required driving force is hard to achieve. Moreover, continuing to run in post-downshift speed stage degrades fuel economy expressed as brake-specific fuel consumption. In addition, a noise issue arises because engine speed stays high. The present embodiment overcomes these issues by configuring the vehicle control apparatus 100 as set out below.

FIG. 6 is a block diagram concretely showing main components of the vehicle control apparatus 100 according to the present embodiment (FIG. 2), particularly those of the vehicle control apparatus 100 related to turn traveling. As shown in FIG. 6, the driving control unit 46 receives signal input from the self/manual drive select switch 33a, the action plan generation unit 45, and the memory unit 42. Based on these input signals, the driving control unit 46 outputs control signals to the throttle actuator 13 and the shift actuator 23. Although illustration is omitted in the drawings, the driving control unit 46 also outputs control signals to a brake actuator and a steering actuator when traveling a curve.

As a functional configurations, the action plan generation unit 45 includes a turn travel determination unit 451. The turn travel determination unit 451 determines from, for example, map data stored in the map database 35 that a curve 104 is present on the travel route, and uses subject vehicle position on a map recognized by the subject vehicle position recognition unit 43 to calculate distance L from current position of the subject vehicle to starting point of the curve 104 (point P3 of FIG. 5). The subject vehicle is determined to have started preparation for turn traveling when distance L shortens to or less than predetermined distance ΔL.

As shown in FIG. 5, predetermined distance ΔL is set as distance from point P3 to, for example, point P1 at which the subject vehicle nears the curve 104 and starts deceleration. More specifically, predetermined distance ΔL is defined as a parameter of vehicle speed to become longer as vehicle speed is faster. The turn travel determination unit 451 determines that the subject vehicle entered the curve 104 and started turn traveling when distance L reaches 0. Optionally, a configuration can be adopted wherein the exterior recognition unit 44 recognizes the curve 104 and start of preparation for turn traveling or start of turn traveling is determined based on a signal from the exterior recognition unit 44. The turn travel determination unit 451 also determines completion of turn traveling.

As functional configurations, the driving control unit 46 includes a shift control unit 47 and an engine control unit 48. As functional configurations, the shift control unit 47 includes a speed stage setting unit 471, a speed stage determination unit 472, and an actuator control unit 473.

The speed stage setting unit 471 is responsive to generation of a turn traveling action plan by the action plan generation unit 45 for setting, based on the generated action plan, a speed stage (target speed stage) desired upon completion of turn traveling (point P4 in FIG. 5). The target speed stage is, for example, set to the highest speed stage able to satisfy required driving force necessary for accelerating to target vehicle speed after completion of turn traveling. For example, in a case where driving force required after completing turn traveling can be satisfied by either fourth speed or fifth speed, target speed stage is set to fifth speed.

The speed stage determination unit 472 determines a magnitude relationship between speed stage at that time (current speed stage) and speed stage set by the speed stage setting unit 471 (target speed stage) when switching from manual drive mode to self-drive mode is instructed by the self/manual drive select switch 33a during deceleration before start of turn traveling (during turn traveling preparation). In other words, the speed stage determination unit 472 determines, inter alia, whether current speed stage is lower than target speed stage.

The actuator control unit 473 is responsive to vehicle traveling in ordinary self-drive mode (e.g., other than when turn traveling) for outputting a control signal to the shift actuator 23 in accordance with a shift map stored in the memory unit 42 (characteristic curve f1 or f2 of FIG. 4) to thereby upshift or downshift the transmission 2. On the other hand, during preparation for turn traveling, the actuator control unit 473 controls speed stage of the transmission 2 in accordance whether the speed stage determination unit 472 determined current speed stage to be higher or lower than target speed stage. Specifically, the actuator control unit 473 upshifts the transmission 2 when the speed stage determination unit 472 determines current speed to be lower (smaller) to than target speed stage, downshifts the transmission 2 when it determines current speed stage to be higher (greater) than target speed stage, and shift-holds the transmission 2 when it determines current speed stage to be the same as target speed stage. As a result, speed stage is controlled to target speed stage by no later that the start of turn traveling.

The engine control unit 48 controls engine torque by outputting a control signal to the throttle actuator 13 so as to produce required driving force. In the particular case of upshifting the transmission 2 when current speed stage is determined to be lower than target speed stage during preparation for turn traveling, engine torque is increased so that vehicle driving force does not change between before and after upshifting.

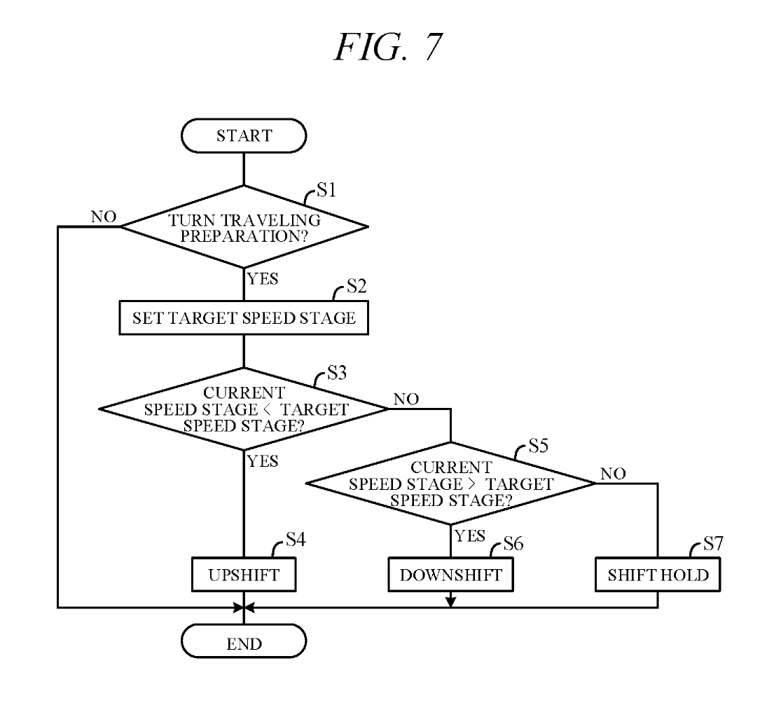

FIG. 7 is a flowchart showing an example of processing performed by the processing unit 41 (CPU) of FIG. 2 in accordance with a program stored in the memory unit 42 in advance. It is specifically a flowchart showing an example of processing related to shift control performed by the action plan generation unit 45 and the driving control unit 46, particularly an example of processing during turn traveling. The processing indicated in this flowchart is an example of processing in self-drive mode and is, for example, started when the self/manual drive select switch 33a instructs switching from manual drive mode to self-drive mode and repeated periodically at predetermined time intervals until turn traveling is completed.

First, in S1 (S: processing Step), the turn travel determination unit 451 determines whether turn traveling preparation prior to entering a curve 104 is in progress. If a positive decision is made in S1, the routine proceeds to S2, and if a negative decision is made, processing is terminated. The determination in S1 is positive (YES) before starting turn traveling. During turn traveling (between point P3 and point P4 in FIG. 5), the determination in S1 is negative (NO), in which case speed stage is maintained until turn traveling is completed.

In S2, the speed stage setting unit 471 sets a post-turn traveling target speed stage based on an action plan generated by the action plan generation unit 45. Next, in S3, the speed stage determination unit 472 determines whether current speed stage is lower than target speed stage set in S2. If a positive decision is made in S3, the routine proceeds to S4, in which the actuator control unit 473 outputs a control signal to the shift actuator 23 to upshift the transmission 2 to the target speed stage, whereupon processing is terminated. The post-upshift speed stage is thereafter maintained through repeated processing cycles until a negative decision is made in S1 and turn traveling is completed.

On the other hand, if a negative decision is made in S3, the routine proceeds to S5, in which the speed stage determination unit 472 determines whether current speed stage is higher than target speed stage. If a positive decision is made in S5, the routine proceeds to S6, in which the actuator control unit 473 outputs a control signal to the shift actuator 23 to downshift the transmission 2 to the target speed stage, whereupon processing is terminated. The post-downshift speed stage is thereafter maintained through repeated processing cycles until a negative decision is made in S1 and turn traveling is completed. If a negative decision is made in S5, the routine proceeds to S7, in which the current speed stage is maintained as is and processing is terminated.

A more detailed explanation of operation of the vehicle control apparatus according to the present embodiment follows. As shown in FIG. 5, the explanation presumes as an example that the subject vehicle is in a state of starting to decelerate at point P1 upon nearing the curve 104 while running at fourth speed in manual drive mode. When during deceleration (during turn traveling preparation), manual drive mode is switched to self-drive mode at point P2, fifth speed is set as post-turn traveling target speed stage (S2) and the transmission 2 upshifts to fifth speed (target speed stage) (S4).

Owing to the upshift, engine speed decreases at this time. This improves quietness of the subject vehicle 101. Moreover, the engine control unit 48 increases throttle opening angle in order to prevent decrease of vehicle driving force, so that engine torque increases. Since this keeps vehicle driving force constant between before and after upshift, subject vehicle behavior stabilizes. Moreover, the increase in engine torque reduces brake-specific fuel consumption and improves fuel economy.

Speed stage is held unchanged in fifth speed during turn traveling (point P3 to point P4) and also remains in fifth speed after completion of turn traveling (point P4 to point P6). So whereas conventionally the transmission 2 would be upshifted to target speed stage (fifth stage) after turn traveling (see comparative example in FIG. 5), in the present embodiment upshifting to the target speed stage is performed before starting to travel along the curve, whereby speed stage is maintained without need to upshift after turn traveling.

The present embodiment can achieve advantages and effects such as the following:

(1) The vehicle control apparatus 100 according to the present embodiment is configured to control the engine 1 mounted on the subject vehicle 101 having self-drive function and the transmission 2 for shifting speed ratio of rotation output from the engine 1. The vehicle control apparatus 100 includes: the action plan generation unit 45 for generating an action plan of the subject vehicle 101; the speed stage setting unit 471 for, prior to the subject vehicle 101 starting turn traveling (traveling along curved road) and based on an action plan generated by the action plan generation unit 45, setting a target speed stage of the transmission 2 capable of generating post-turn traveling required driving force, e.g., a target speed stage for accelerating to post-turn traveling target vehicle speed; the speed stage determination unit 472 for determining higher-lower relationship between current speed stage before the subject vehicle 101 starts turn traveling and target speed stage set by the speed stage setting unit 471; and the actuator control unit 473 for controlling the transmission 2 in accordance with higher-lower relationship between current speed stage and target speed stage (FIG. 6). When the speed stage determination unit 472 determines current speed stage to be lower than target speed stage, the actuator control unit 473 upshifts the transmission 2 to set current speed stage as target speed stage.

Since this enables upshifting of the transmission 2 before turn traveling, change of vehicle driving force relative to change of throttle opening angle can be reduced in the vehicle using the engine 1 as a drive power source. As a result, vehicle control performance improves and actual driving force can be accurately matched to required driving force by feedback control. Moreover, since upshifting and downshifting of the transmission 2 are prohibited and speed stage prior to turn traveling is held during turn traveling, vehicle behavior stabilizes and smooth turn traveling can be achieved. In addition, excellent quietness is realized because upshifting lowers engine speed. Although post-turn traveling acceleration decreases when the transmission 2 is upshifted, lower acceleration is not a practical problem because in self-drive mode emphasis is more on fuel-efficient, quiet driving than on acceleration performance.

(2) The vehicle control apparatus 100 further includes the engine control unit 48 for controlling the engine 1 so that vehicle driving force (first travel driving force) after upshifting of the transmission 2 by the actuator control unit 473 is equal to vehicle driving force (second travel driving force) before upshifting (FIG. 6). Since vehicle driving force can therefore be held constant between before and after upshifting, vehicle behavior stabilizes. Moreover, Since engine torque increases when the transmission 2 is upshifted, brake-specific fuel consumption decreases and fuel economy improves. This is because the engine 1 generally has a good fuel economy region on high torque side, so that increasing engine torque improves fuel economy.

(3) When the speed stage determination unit 472 determines current speed stage to be higher than target speed stage, the actuator control unit 473 downshifts the transmission 2 to set current speed stage as target speed stage (S6). Since this enables quick acceleration after turn traveling, rapid acceleration to target vehicle speed is possible when, for example, following another vehicle.

(4) The vehicle control apparatus 100 further includes the self/manual drive select switch 33a for instructing switching from manual drive mode to self-drive mode or switching from self-drive mode to manual drive mode (FIG. 6). When during turn traveling preparation the self/manual drive select switch 33a instructs switching from manual drive mode to self-drive mode and the speed stage determination unit 472 determines current speed stage to be lower than target speed stage, the actuator control unit 473 upshifts the transmission 2 to set current speed stage as target speed stage. Since shifting of the transmission is controlled in accordance with different characteristics in manual drive mode and self-drive mode (FIG. 4), shifting inappropriate for turn traveling is apt to occur when switching from manual drive mode to self-drive mode before turn traveling. Therefore, by adopting a configuration that upshifts the transmission 2 in response to instruction to switch from manual drive mode to self-drive mode, it becomes possible to achieve turn traveling of enhanced stability, quietness and fuel efficiency performance.

Various modifications of the present embodiment are possible. Some examples are explained in the following. In the aforesaid embodiment, the speed stage determination unit 472 determines higher-lower relationship between speed stage during deceleration (during turn traveling preparation) and target speed stage, but it can instead determine higher-lower relationship between speed stage after completion of deceleration but before start of turn traveling and target speed stage. In the aforesaid embodiment, when the speed stage determination unit 472 determines during deceleration that current speed stage is lower than target speed stage, the transmission 2 is upshifted to set current speed stage as target speed stage, but upshifting can instead be performed after completion of deceleration but before start of turn traveling.

The aforesaid embodiment is explained with respect to an example using a stepped transmission as the transmission 2, but a continuously variable transmission can be used instead. Therefore, a speed ratio setting unit is not limited to the speed stage setting unit 471 but can be of any configuration insofar as capable of setting a target speed ratio. Further, a speed ratio determination unit is not limited to the speed stage determination unit 472 but can be of any configuration insofar as capable of determining whether a current speed ratio during deceleration traveling or after the deceleration traveling before the subject vehicle starts turn traveling is greater or smaller than a target speed ratio. In addition, the actuator control unit is not limited to the actuator control unit 473 but can be of any configuration insofar as capable of controlling the transmission in accordance with greater-smaller of the current speed ratio and the target speed ratio, more exactly, insofar as capable of controlling the transmission to high speed stage side so as to decrease speed ratio to target speed ratio before the subject vehicle starts turn traveling, when current speed ratio is determined to be greater than target speed ratio. Regarding to a relationship between speed ratio and speed stage, speed ratio is greater as speed stage is lower, i.e., as speed stage comes closer to first speed stage, and speed ratio is smaller as speed stage is higher. In the aforesaid embodiment, the self/manual drive select switch 33a instructs one of the other of manual drive mode and self-drive mode, but a mode instruction switch can be of any configuration. For example, the driver can be allowed to instruct mode switching by voice input. In the aforesaid embodiment, switching to only a single self-drive mode is enabled but it is also possible to enable switching to any of multiple self-drive modes. For example, a mode that behaves like the comparative example of FIG. 5 can be made selectable by switch operation as a mode placing priority on power performance. The aforesaid embodiment is explained with respect to an example of controlling shifting of the transmission when the self/manual drive select switch 33a instructs switching to self-drive mode during turn traveling preparation, but shifting can be similarly controlled when switching to self-drive mode is instructed before turn traveling preparation. Therefore, the present invention can be similarly applied to a vehicle not having a mode instruction switch, e.g., a self-driving vehicle that travels solely in self-drive mode. The present invention can also be similarly applied to a vehicle equipped with a power source other than an engine.

The present invention can also be used as a vehicle control method configured to control a drive power source and a transmission connected to the drive power source mounted on a vehicle having a self-drive function.

The above embodiment can be combined as desired with one or more of the above modifications. The modifications can also be combined with one another.

According to the present invention, it is possible to improve control performance at a time of turn traveling of a vehicle having a self-drive function.

Above, while the present invention has been described with reference to the preferred embodiments thereof, it will be understood, by those skilled in the art, that various changes and modifications may be made thereto without departing from the scope of the appended claims.

What is claimed is:

1. A vehicle control apparatus configured to control a drive power source and a transmission connected to the drive power source, the drive power source and the transmission being mounted on a vehicle having a self-drive function, the vehicle control apparatus comprising:
an electric control unit including a microprocessor and a memory,
wherein the microprocessor is configured to perform:
generating an action plan of the vehicle;
setting a target speed ratio of the transmission corresponding to a required driving force required after completion of a turn traveling of the vehicle based on the action plan generated in the generating, before the vehicle starts the turn traveling;
determining whether a current speed ratio during deceleration traveling or after the deceleration traveling before the vehicle starts the turn traveling is greater or smaller than the target speed ratio set in the setting;
controlling the transmission in accordance with a result determined by the determining, and
the controlling including controlling the transmission so as to decrease a speed ratio to the target speed ratio before the vehicle starts the turn traveling, when it is determined that the current speed ratio is greater than the target speed ratio.

2. The apparatus according to claim 1, wherein
the microprocessor is configured to further perform
controlling the drive power source so that a first travel driving force after the transmission is controlled so as to decrease the speed ratio to the target speed ratio is equal to a second travel driving force before the transmission is controlled so as to decrease the speed ratio to the target speed ratio.

3. The apparatus according to claim 1, wherein
the microprocessor is configured to perform
the controlling including controlling the transmission when it is determined that the current speed ratio is greater than the target speed ratio, so as to decrease the speed ratio to the target speed ratio before the vehicle starts the turn traveling, and then so as to maintain the speed ratio at the target speed ratio until the vehicle completes the turn traveling.

4. The apparatus according to claim 1, wherein
the microprocessor is configured to perform
the controlling including controlling the transmission so as to increase the speed ratio to the target speed ratio before the vehicle starts the turn traveling, when it is determined that the current speed ratio is smaller than the target speed ratio.

5. The apparatus according to claim 1, wherein
the microprocessor is configured to perform
the controlling including controlling the transmission so as to maintain the speed ratio at the current speed ratio, when the current speed ratio is equal to the target speed ratio.

6. The apparatus according to claim 1, further comprising a mode instruction switch configured to instruct switching from a manual drive mode to a self-drive mode or from the self-drive mode to the manual drive mode, wherein
the microprocessor is configured to perform
the controlling including controlling the transmission so as to decrease the speed ratio to the target speed ratio before the vehicle starts the turn traveling, when the switching from the manual drive mode to the self-drive mode is instructed by the mode instruction switch during the deceleration traveling or after the deceleration traveling before the vehicle starts the turn traveling and when it is determined that the current speed ratio is greater than the target speed ratio.

7. A vehicle control apparatus configured to control a drive power source and a transmission connected to the drive power source, the drive power source and the transmission being mounted on a vehicle having a self-drive function, the vehicle control apparatus comprising:
an electric control unit including a microprocessor and a memory,
wherein the microprocessor is configured to function as:
an action plan generation unit configured to generate an action plan of the vehicle;
a speed ratio setting unit configured to set a target speed ratio of the transmission corresponding to a required driving force required after completion of a turn traveling of the vehicle based on the action plan generated by the action plan generation unit, before the vehicle starts the turn traveling;
a speed ratio determination unit configured to determine whether a current speed ratio during deceleration traveling or after the deceleration traveling before the vehicle starts the turn traveling is greater or smaller than the target speed ratio set by the speed ratio setting unit; and
a shift control unit configured to control the transmission in accordance with a result determined by the speed ratio determination unit, and
wherein the shift control unit is configured to control the transmission so as to decrease a speed ratio to the target speed ratio before the vehicle starts the turn traveling, when it is determined that the current speed ratio is greater than the target speed ratio.

8. The apparatus according to claim 7, wherein
the microprocessor is configured to further function as
a power source control unit configured to control the drive power source so that a first travel driving force after the transmission is controlled so as to decrease the speed ratio to the target speed ratio is equal to a second travel driving force before the transmission is controlled so as to decrease the speed ratio to the target speed ratio.

9. The apparatus according to claim 7, wherein
the shift control unit is configured to control the transmission when it is determined that the current speed ratio is greater than the target speed ratio, so as to decrease the speed ratio to the target speed ratio before the vehicle starts the turn traveling, and then so as to maintain the speed ratio at the target speed ratio until the vehicle completes the turn traveling.

10. The apparatus according to claim 7, wherein
the shift control unit is configured to control the transmission so as to increase the speed ratio to the target speed ratio before the vehicle starts the turn traveling, when it is determined that the current speed ratio is smaller than the target speed ratio.

11. The apparatus according to claim 7, wherein
the shift control unit is configured to control the transmission so as to maintain the speed ratio at the current speed ratio, when the current speed ratio is equal to the target speed ratio.

12. The apparatus according to claim 7, further comprising a mode instruction switch configured to instruct switching from a manual drive mode to a self-drive mode or from the self-drive mode to the manual drive mode, wherein
the shift control unit is configured to control the transmission so as to decrease the speed ratio to the target speed ratio before the vehicle starts the turn traveling, when the switching from the manual drive mode to the self-drive mode is instructed by the mode instruction switch during the deceleration traveling or after the deceleration traveling before the vehicle starts the turn traveling and when it is determined that the current speed ratio is greater than the target speed ratio.

13. A vehicle control method configured to control a drive power source and a transmission connected to the drive power source, the drive power source and the transmission being mounted on a vehicle having a self-drive function, the vehicle control method comprising:
generating an action plan of the vehicle;
setting a target speed ratio of the transmission corresponding to a required driving force required after completion of a turn traveling of the vehicle based on the action plan generated in the generating, before the vehicle starts the turn traveling;
determining whether a current speed ratio during deceleration traveling or after the deceleration traveling before the vehicle starts the turn traveling is greater or smaller than the target speed ratio set in the setting; and
controlling the transmission in accordance with a result determined in the determining, wherein
the controlling includes controlling the transmission so as to decrease a speed ratio to the target speed ratio before the vehicle starts the turn traveling, when it is determined in the determining that the current speed ratio is greater than the target speed ratio.

14. The method according to claim 13, further comprising
controlling the drive power source so that a first travel driving force after the transmission is controlled so as to decrease the speed ratio to the target speed ratio is equal to a second travel driving force before the transmission is controlled so as to decrease the speed ratio to the target speed ratio.

15. The method according to claim 13, wherein
the controlling includes controlling the transmission when it is determined that the current speed ratio is greater than the target speed ratio, so as to decrease the speed ratio to the target speed ratio before the vehicle starts the turn traveling, and then so as to maintain the speed ratio at the target speed ratio until the vehicle completes the turn traveling.

16. The method according to claim 13, wherein
the controlling includes controlling the transmission so as to increase the speed ratio to the target speed ratio before the vehicle starts the turn traveling, when it is determined that the current speed ratio is smaller than the target speed ratio.

17. The method according to claim 13, wherein
the controlling includes controlling the transmission so as to maintain the speed ratio at the current speed ratio, when the current speed ratio is equal to the target speed ratio.

18. The method according to claim 13, further comprising instructing switching from a manual drive mode to a self-drive mode or from the self-drive mode to the manual drive mode, wherein
the controlling includes controlling the transmission so as to decrease the speed ratio to the target speed ratio before the vehicle starts the turn traveling, when the switching from the manual drive mode to the self-drive mode is instructed during the deceleration traveling or after the deceleration traveling before the vehicle starts the turn traveling and when it is determined that the current speed ratio is greater than the target speed ratio.
